(19) United States
(12) Patent Application Publication
(10) Pub. No.: US 2010/0328366 A1
(43) Pub. Date: Dec. 30, 2010

(54) DISPLAY DEVICE AND DISPLAY METHOD

(75) Inventors: Norihiro Nakamura, Mobara (JP); Hajime Akimoto, Kokubunji (JP); Junichi Yokoyama, Fujisawa (JP); Fumio Haruna, Yokohama (JP); Masami Iseki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/825,669

(22) Filed: Jun. 29, 2010

(30) Foreign Application Priority Data
Jun. 30, 2009 (JP) 2009-155757

(51) Int. Cl. G09G 5/10

(52) U.S. Cl. 345/690

(57) ABSTRACT

A display device is provided which displays images by emitting light when a reference voltage is applied to pixels. An average picture level calculation unit of a reference voltage calculation unit in a rectangular wave driving unit of a TFT substrate calculates the value of average picture level, and a ΔV calculation unit of a reference voltage calculation unit calculates a correction amount ΔV of the reference voltage based on the average picture level value. The calculated correction amount ΔV is added to a reference voltage and is used as the voltage of a rectangular wave signal that is output to each pixel from a rectangular wave driving unit. In each pixel in which a data signal corresponding to the grayscale value is stored, an organic EL device emits light in accordance with the rectangular wave signal.

### CROSS-REFERENCE TO RELATED APPLICATION

The present application claims priority from Japanese application JP2009-155757 filed on Jun. 30, 2009, the content of which is hereby incorporated by reference into this application.

### BACKGROUND OF THE INVENTION

1. Field of the Invention

The present invention relates to a display device and a display method, and more particularly, to a display device which displays images by causing a light emitting device to emit light when a reference voltage is applied to a plurality of pixels in which a voltage based on a grayscale value is stored, and a display method of the light emitting display device.

2. Description of the Related Art

In recent years, image display devices (hereinafter referred to as “organic EL display devices”) that use a self-luminous body called an organic electro-luminescent (EL) device, as represented by an organic light emitting diode are at the stage of practical use. The organic EL display devices not only have excellent visibility and response speed, due to the use of a self-luminous body, compared to conventional liquid-crystal display devices, but also can be made thinner since an auxiliary illumination unit such as a backlight is not needed.

As a driving method of such organic EL display devices, for example, JP 2003-005709 A discloses an organic EL display device based on a driving method, so-called CI (Clamped Inverter) driving method, in which organic EL devices are caused to emit light when a reference voltage is applied to a plurality of pixels in which a voltage based on a grayscale value is stored in a storage capacitor.

As a method of improving display quality of the organic EL display devices, a method of increasing luminance is generally considered. However, when the deterioration and power consumption of the organic EL devices which are self-luminous bodies are taken into account, it may be difficult to improve the display quality by increasing the luminance of the organic EL devices. As an example of the method of improving display quality, JP 2004-126168 A discloses an organic EL display device that is driven based on a pulse width modulation (PWM) driving method, in which luminance characteristics at each grayscale are changed based on luminance distribution of a display image.

### SUMMARY OF THE INVENTION

In the CI driving method, when the organic EL display device is used in a mobile apparatus such as a digital still camera, it is necessary to ensure sufficient visibility out of doors. In particular, when an image, in which the average grayscale value on the entire screen is high, such as an image that is captured at an outdoor place, is displayed with the organic EL display device, the following problem may arise. When there is insufficient electricity to be supplied to an organic EL panel, an image that should be displayed at a high luminance will be displayed at a low luminance, and the contrast becomes so low that the image is not clear.

The invention has been made in view of the circumstances described above, and an object of the invention is to provide a driving method of a display device having a current-driving light emitting device such as an EL device, capable of simplifying the configuration of a driving circuit over a conventional circuit and controlling the luminance of each pixel over a wide range from high luminance to low luminance while keeping balanced lighting intensity. Another object of the invention is to provide an organic EL display device having improved contrast and increased visibility.

According to an aspect of the invention, there is provided a display device including: a light emitting device, which is a self-luminous body, emits light when a reference voltage is applied to a plurality of pixels in which voltages based on grayscale values are stored; an aggregate amount calculation unit that calculates an aggregate amount of grayscale values of the plurality of pixels for one screen; a reference voltage correction unit that calculates a correction amount of the reference voltage based on the aggregate amount to correct the reference voltage; and a reference voltage output unit that outputs the reference voltage based on the reference voltage corrected by the reference voltage correction unit.

In the display device of the invention, the light emitting device may be an organic electro-luminescent device.

In the display device of the invention, the aggregate amount may be an average picture level that is expressed by the sum of the grayscale values. In addition, the aggregate amount may be a weighted sum with a different weight for each color.

In the display device of the invention, the reference voltage correction unit may correct the reference voltage so that lighting intensity of the light emitting device is decreased when the aggregate amount has a value indicating a high degree of brightness and, may correct the reference voltage so that lighting intensity of the light emitting device is increased when the aggregate amount has a value indicating a low degree of brightness.

In the display device of the invention, the reference voltage correction unit may correct the reference voltage so that the peak luminance of the light emitting device is increased when the aggregate amount has a value indicating a high degree of brightness and, may correct the reference voltage so that the peak luminance of the light emitting device is decreased when the aggregate amount has a value indicating a low degree of brightness.

In the display device of the invention, the reference voltage correction unit may include parameters for calculating the correction amount and determine the correction amount by substituting the aggregate amount into a calculation equation using the parameters. In this case, the parameters may be determined based on settings input by a user, ambient light intensity, a continuous use time, and the like. The parameters may include a parameter that selects whether or not the reference voltage will be corrected.

In the display device of the invention, the aggregate amount calculation unit, the reference voltage correction unit, and the reference voltage output unit may be configured by a circuit on a TFT substrate having the pixels.

According to another aspect of the invention, there is provided a display method of a display device including: an aggregate amount calculation step of calculating an aggregate amount of grayscale values of a plurality of pixels; a reference voltage correction step of calculating a correction amount of the reference voltage based on the aggregate amount calculated in the aggregate amount calculation step to correct the reference voltage; and a reference voltage output step of outputting the reference voltage based on the reference voltage corrected in the reference voltage correction step so as to emit light by a light emitting device, which is a self-luminous body, at the plurality of pixels in which voltages based on the grayscale values are stored.

### BRIEF DESCRIPTION OF THE DRAWINGS

FIG. 1 is a diagram showing an organic EL display device according to a first embodiment of the invention.

FIG. 2 is a diagram schematically showing a TFT substrate according to the first embodiment.

FIG. 3 is a diagram schematically showing a circuit in a pixel.

FIG. 4 is a diagram showing a configuration of a rectangular wave driving unit.

FIG. 5 is a flowchart showing the processes executed by a reference voltage calculation unit.

FIG. 6 is a flowchart showing an outdoor-mode correction amount ΔV addition process.

FIG. 7 is a flowchart showing an APL calculation process.

FIG. 8 is a flowchart showing a ΔV calculation process.

FIG. 9 is a graph showing the relationship between a correction amount and an APL.

FIG. 10 is a timing chart showing the changes in signals being controlled when an organic EL device is lighted.

FIG. 11 is a diagram schematically showing a TFT substrate according to a second embodiment.

FIG. 12 is a diagram schematically showing a circuit in a pixel.

FIG. 13 is a timing chart showing the changes in signals being controlled when an organic EL device is lighted.

FIG. 14 is a graph showing the relationship between a correction amount and an APL.

FIG. 15 is a graph showing the relationship between a peak luminance L and an APL.

### DETAILED DESCRIPTION OF THE INVENTION

Hereinafter, the first and second embodiments of the invention will be described in detail with reference to the drawings. In the drawings, the same or equivalent elements will be denoted by the same reference numerals, and redundant description thereof will be omitted.

### First Embodiment

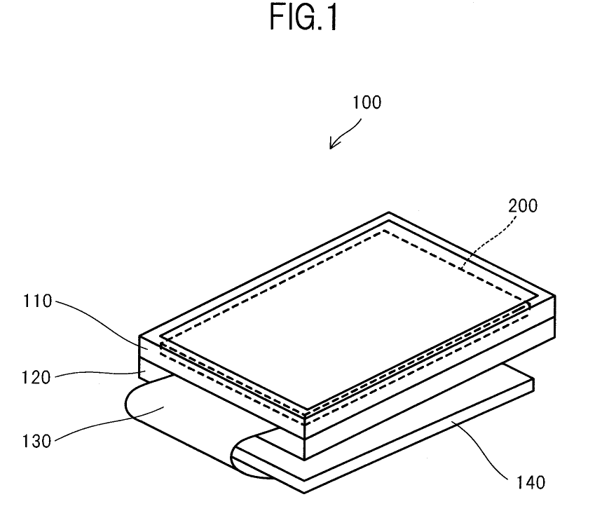

FIG. 1 is a diagram showing an organic EL display device 100 according to the first embodiment of the invention. As shown in the figure, the organic EL display device 100 includes an upper frame 110 and a lower frame 120 that are fixed so as to sandwich an organic EL panel which includes a thin film transistor (TFT) substrate 200 and a sealing substrate not shown, a circuit board 140 that includes circuit elements for generating information to be displayed, and a flexible substrate 130 that transfers RGB information generated by the circuit board 140 to the TFT substrate 200.

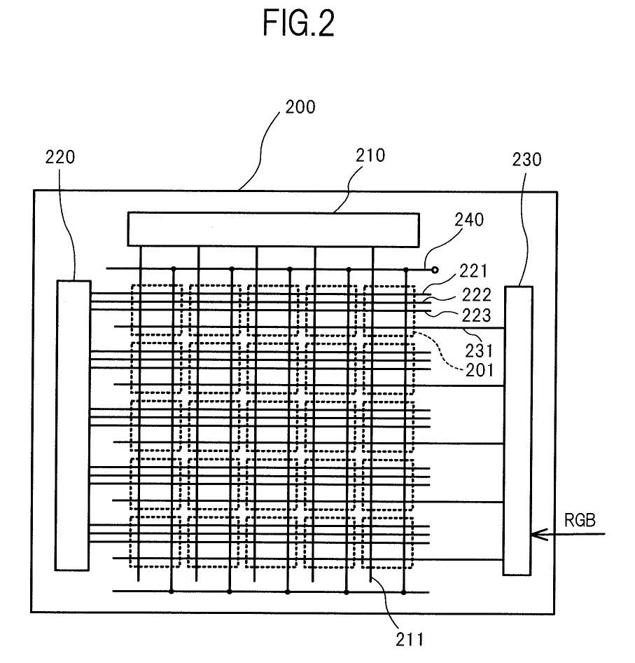

FIG. 2 schematically shows the TFT substrate 200 shown in FIG. 1. The TFT substrate 200 includes pixels 201 which are minimum display units and are arranged in a matrix form, a data signal driving unit 210 that outputs a data signal 211 corresponding to a grayscale value to be displayed to each pixel 201, a gate driving unit 220 that outputs a signal for controlling TFT switches arranged in each pixel 201, and a rectangular wave driving unit 230 that outputs a rectangular wave signal 231 which is an emission period signal of a rectangular wave for achieving lighting.

Here, the signal that is output from the gate driving unit 220 to each pixel 201 includes a signal select signal 221, a lighting control signal 222, and a reset signal 223, which will be described later. In the figure, only a small number of pixels 201 are shown in a simplified configuration so as not to complicate the figure.

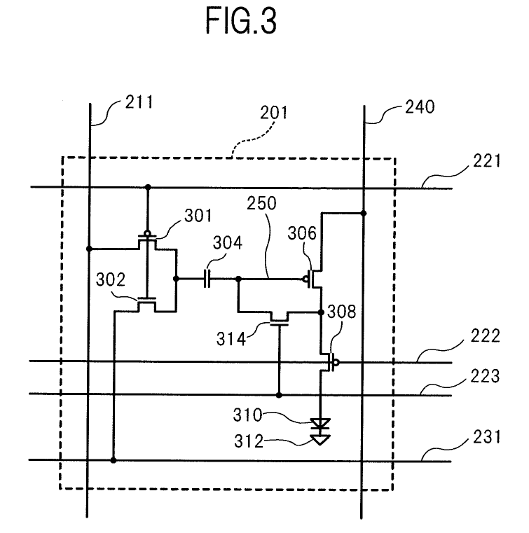

FIG. 3 schematically shows a circuit in the pixel 201. As shown in the figure, the pixel 201 includes an organic EL device 310 which is a self-luminous body, a first select switch 301 and a second select switch 302 that are configured to select either one of the rectangular wave signal 231 and the data signal 211 to be input to an input signal line 250, an organic EL driving TFT 306 which functions as a switch that lights the organic EL device 310, and which has a drain connected to the anode side of the organic EL device 310 via a lighting control switch 308 described later, a storage capacitor 304 that is disposed between the first and second select switches 301 and 302 and a gate side of the organic EL driving TFT 306, a reset switch 314 which is connected so as to connect the drain and gate sides of the organic EL driving TFT 306 and which is operated by the reset signal 223, a lighting control switch 308 which is disposed on the drain side of the organic EL driving TFT 306 and is driven by the lighting control signal 222, and a common electrode 312 that is connected to the cathode side of the organic EL device 310. In addition, a power supply line 240 is connected to a source side of the organic EL driving TFT 306.

The first select switch 301, the organic EL driving TFT 306, and the lighting control switch 308 are formed by PMOS transistors and they will be turned on when the gate signal thereof is Low. On the other hand, the second select switch 302 and the reset switch 314 are formed by NMOS transistors and they will be turned on when the gate signal thereof is High.

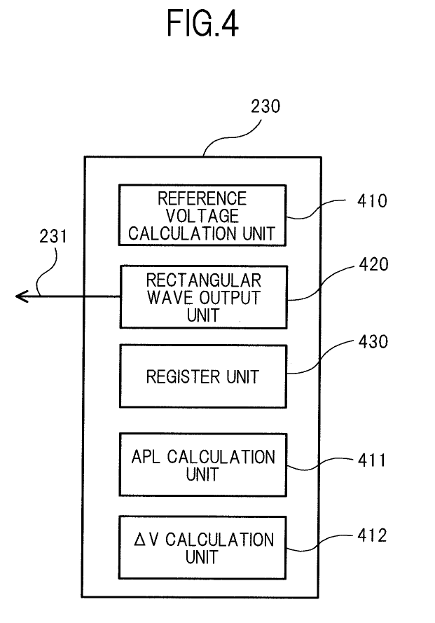

FIG. 4 schematically shows a configuration of the rectangular wave driving unit 230. The rectangular wave driving unit 230 includes a reference voltage calculation unit 410 that calculates a voltage value of the emission period signal of the rectangular wave, a rectangular wave output unit 420 that outputs the rectangular wave signal 231 with a voltage calculated by the reference voltage calculation unit 410, and a register unit 430 that stores constants necessary for calculating the reference voltage. In addition, the rectangular wave driving unit 230 includes an APL calculation unit 411 that calculates an average picture level (APL) value and a ΔV (correction voltage) calculation unit 412 that calculates a correction amount (correction voltage) ΔV of a voltage based on the value of APL calculated by the APL calculation unit 411.

That is, an aggregate amount (aggregate voltage) calculated by the APL calculation unit 411 which is an aggregate amount calculation unit is voltage data that are aggregately obtained from image data. In addition, a reference voltage correction unit is constituted by the correction voltage calculation unit 412 and the reference voltage calculation unit 410. A corrected reference voltage (correction reference voltage) is calculated based on the correction voltage ΔV calculated by the correction voltage calculation unit 412 and the reference voltage calculated by the reference voltage calculation unit 410. The correction reference voltage is output through the reference voltage output unit. In FIG. 4, the reference voltage output unit is the rectangular wave output unit 420.

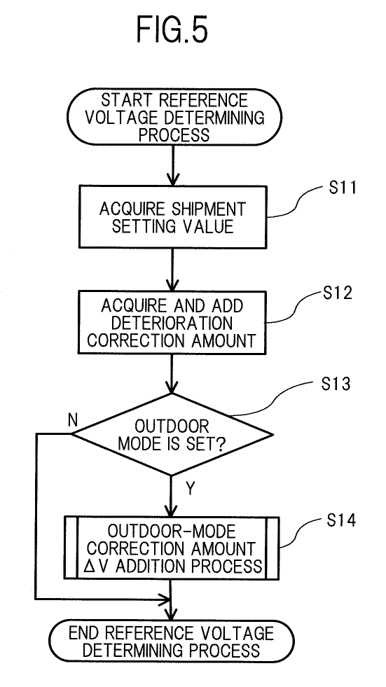

FIG. 5 is a flowchart showing the processes executed by the reference voltage calculation unit 410. First, in step S11, the reference voltage calculation unit 410 reads a shipment setting value for the reference voltage from the register unit 430. Subsequently, in step S12, the reference voltage calculation unit 410 acquires an deterioration correction amount calculated from continuous use time or the like and adds the deterioration correction amount to the shipment setting value. After that, in step S13, it is determined whether an outdoor mode is set by a user. If the determination result is affirmative, the flow proceeds to step S14 to execute an outdoor-mode correction amount ΔV addition process. After the correction amount ΔV in the outdoor mode is added, the process ends. On the other hand, if the determination result is negative, the process ends there.

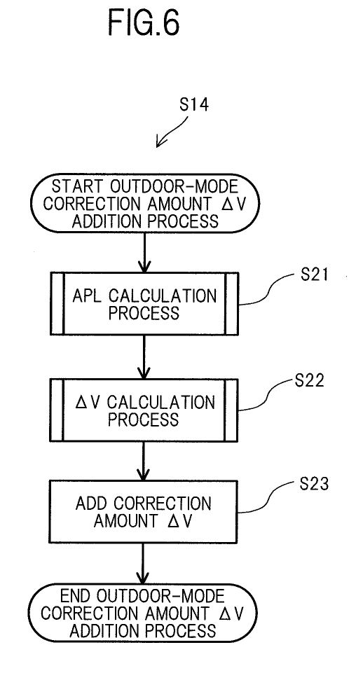

FIG. 6 is a flowchart showing an outdoor-mode correction amount ΔV addition process in step S14 of FIG. 5. In the process (step S14) of adding the correction voltage ΔV in the outdoor mode, first, an APL calculation process for calculating the value of APL (average picture level) is performed in step S21 and subsequently, a ΔV calculation process for calculating the correction amount ΔV is executed in step S22 based on the calculated APL value. Lastly, in step S23, the calculated correction amount ΔV is added to the reference voltage.

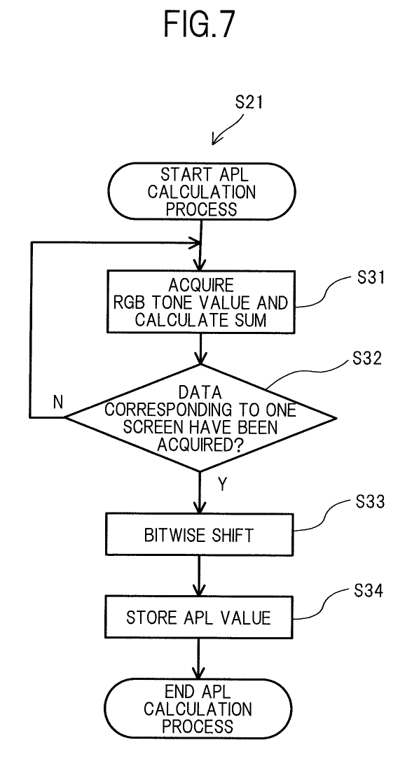

FIG. 7 is a flowchart showing the APL calculation process in step S21 of FIG. 6. The APL calculation process (step S21) is performed in the following manner. First, in step S31, grayscale values of the colors R (red), G (green), and B (blue) to be displayed on a screen are acquired from the circuit board 140 shown in FIG. 1, and the sum of these values is calculated. This process is repeated until the sum of data corresponding to one screen is calculated (step S32). In this case, when the sum is calculated for each RGB color, a weighted sum may be calculated, for example, by multiplying 1.3 with respect to the grayscale value of B (blue). Subsequently, in step S33, the summed information is bitwise shifted so that only the upper bits are left, and the information thus obtained is used as the value of APL. In step S34, the APL value is stored.

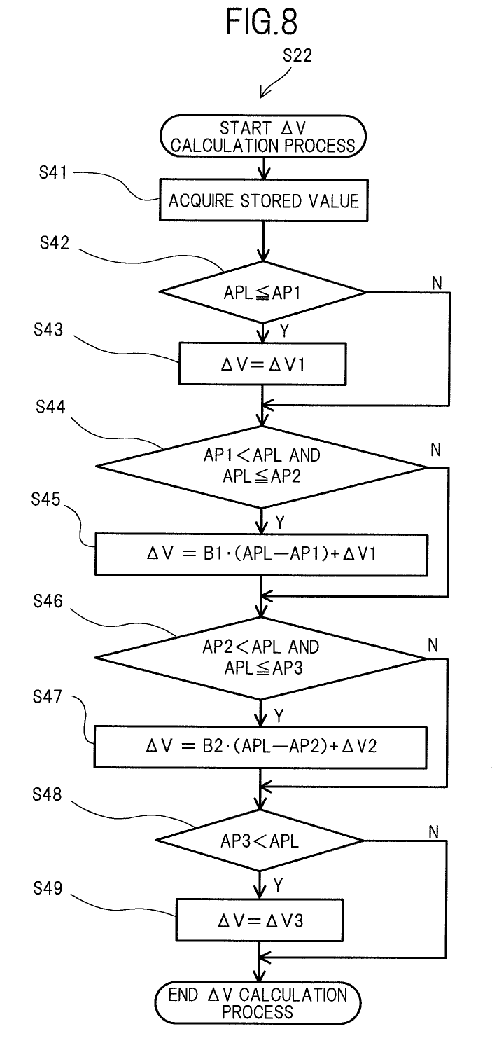

FIG. 8 is a flowchart showing the ΔV calculation process in step S22 of FIG. 6. The ΔV calculation process (step S22) is performed in the following manner. First, in step S41, the APL value calculated by the APL calculation process in step S21 and respective values of AP1, AP2, AP3, ΔV1, ΔV2, and ΔV3 which are parameters for calculating the correction amount ΔV and stored in the register unit 430 are read and acquired.

Subsequently, in step S42, it is determined whether or not the APL value is equal to or smaller than AP1. If the determination result is affirmative, in step S43, ΔV1 is substituted into ΔV, and the flow proceeds to step S44. On the other hand, if the determination result is negative, the flow proceeds to step S44 without executing the substitution in step S43.

After that, in step S44, it is determined whether or not the APL value is greater than AP1 and not greater than AP2. If the determination result is affirmative, in step S45, a calculation result of B1·(APL−AP1)+ΔV1 is substituted into ΔV, and the flow proceeds to step S46. On the other hand, if the determination result is negative, the flow proceeds to step S46 without executing the substitution in step S45. Here, B1 is an amount expressed by (ΔV2−ΔV1)/(AP2−AP1).

Subsequently, in step S46, it is determined whether or not the APL value is greater than AP2 and not greater than AP3. If the determination result is affirmative, in step S47, a calculation result of B2·(APL−AP2)+ΔV2 is substituted into ΔV, and the flow proceeds to step S48. On the other hand, if the determination result is negative, the flow proceeds to step S48 without executing the substitution in step S47. Here, B2 is an amount expressed by (ΔV3−ΔV2)/(AP3−AP2).

After that, in step S48, it is determined whether or not the APL value is greater than AP3. If the determination result is affirmative, in step S49, ΔV3 is substituted into ΔV, and the ΔV calculation process (step S22) ends. On the other hand, if the determination result is negative, the ΔV calculation process (step S22) ends without executing the substitution in step S49. The thus-calculated correction amount ΔV is added to the reference voltage in step S23 of FIG. 6.

In FIG. 5, the outdoor-mode correction amount ΔV addition process (step S14) is not executed when the outdoor mode is not set. Instead of this, ΔV may be set to 0 V in the ΔV calculation process (step S22) in FIG. 8.

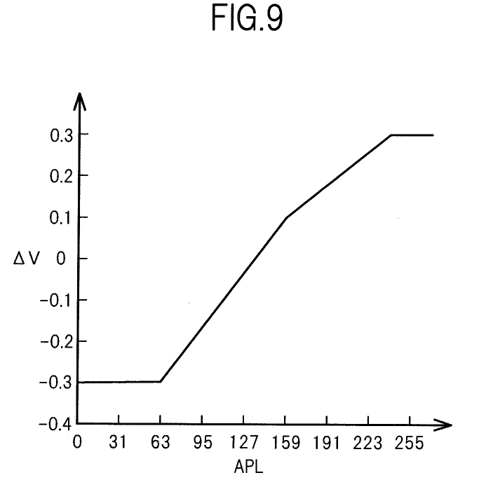

FIG. 9 is a graph showing the relationship between the correction amount ΔV and the APL calculated by the ΔV calculation process in FIG. 8. In the graph, the respective parameter values read from the register unit 430 are given as follows: AP1=64, AP2=160, AP3=240, ΔV1=−0.3, ΔV2=0.1, and ΔV3=0.3. As shown in the graph, the correction amount ΔV increases as the APL value increases.

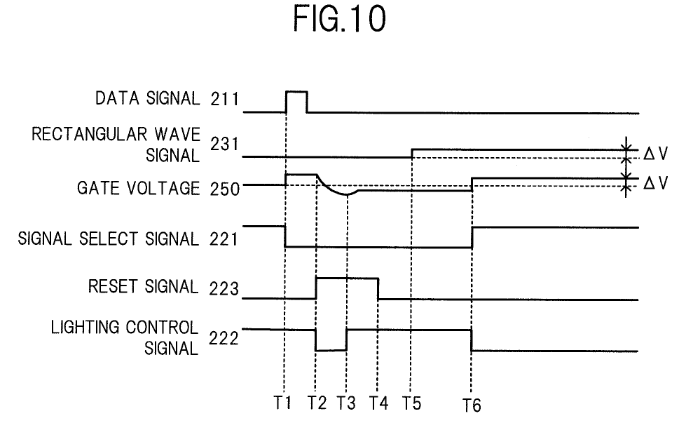

FIG. 10 is a timing chart showing changes in signals being controlled when the organic EL device 310 shown in FIG. 3 is lighted. The timing chart shows the patterns of the changes in the respective signals of the data signal 211, the rectangular wave signal 231, the gate voltage signal 250 of the organic EL driving TFT 306, the signal select signal 221, the reset signal 223, and the lighting control signal 222 shown in FIG. 3.

As shown in the figure, first, at time T1, the signal select signal 221 becomes Low. In response to this, the first select switch 301 shown in FIG. 3 is turned on and the second select switch 302 is turned off. Thus, the data signal 211 is input to the storage capacitor 304. At this point of time T1, the reset signal 223 is in the Low (negative) state and the reset switch 314 is in the Off state.

Subsequently, at time T2, the reset signal 223 becomes High (active) and the reset switch 314 is turned on. At the same time, the lighting control signal 222 becomes Low (active) and the lighting control switch 308 is turned on. In response to this, the gate and drain of the organic EL driving TFT 306 become conductive, and current flows from the power supply line 240 to the common electrode 312 through the PN junction and gate line of the organic EL driving TFT 306. At this time, the gate voltage 250 of the organic EL driving TFT 306 falls to a gate voltage corresponding to the current flowing of the organic EL device 310.

Subsequently, at time T3, when the lighting control signal 222 becomes High (negative), the lighting control switch 308 is turned off, and the gate voltage 250 of the organic EL driving TFT 306 rises, so that the organic EL driving TFT 306 becomes nonconductive at the point of time at which the gate voltage 250 reaches a threshold voltage of the organic EL driving TFT 306. After that, at time T4, the reset signal 223 becomes Low (negative) and the reset switch 314 is turned off. In response to this, at time T4, the voltage of the data signal input to the input signal line 250 becomes the voltage of data corresponding to the grayscale value. As a result, the gate voltage 250 of the organic EL driving TFT 306 is also pulled down through the storage capacitor 304, whereby current corresponding to the data flows from the source side to the gate side, and a charge amount corresponding to the grayscale value is set to the storage capacitor 304.

After that, at time T5, the reference voltage determined by the reference voltage determining process in FIG. 5 is set to the rectangular wave signal 231. In the present embodiment, it will be assumed that the outdoor mode is set, and the APL value obtained by the APL calculation process (step S21) is 224. In this case, in step S46 of the ΔV calculation process (step S22) in FIG. 8, the determination result will be affirmative, and the correction amount ΔV will be 0.26 V as calculated by the equation in step S47. Therefore, at time T5 in FIG. 10, the voltage of the rectangular wave signal 231 will be pulled up by 0.26 V which is the correction amount ΔV.

Subsequently, at time T6, the signal select signal 221 is set to High, and the lighting control signal 222 becomes Low (active). In response to this, the first select switch 301 is turned off and the second select switch 302 is turned on. Therefore, the rectangular wave signal 231 is input to the input signal line 250, and the lighting control switch 308 will be turned on. In this way, a voltage corresponding to the rectangular wave voltage applied to the input signal line 250 appears on the gate side of the organic EL driving TFT 306, and current flows towards the gate side. As a result, current flows from the source side of the organic EL driving TFT 306 to the drain side, and the organic EL device 310 is lighted.

In this case, since the rectangular wave signal 231 is pulled up by the correction amount ΔV, the voltage appearing on the gate side will be also pulled up, then a potential difference between the source terminal and the gate terminal of the organic EL driving TFT 306 will decrease. Therefore, the lighting intensity will be smaller than that when the correction amount ΔV is not used.

Accordingly, in the first embodiment of the invention, even when an image is bright over the entire screen due to a reason such as being captured in a bright outdoor place, it is possible to secure sufficient contrast and visibility.

In addition, as described above, with the sufficient contrast, it is possible to suppress power consumption and extend the lifespan of the organic EL device 310.

In addition, since the luminance on the entire screen is changed by changing the reference voltage, it is possible to change the luminance on the entire screen regardless of the data corresponding to the grayscale value stored for each pixel.

In addition, as shown in FIGS. 8 and 9, when the APL value is small, the correction amount ΔV has a negative value. Therefore, when the entire screen is dark, it is possible to increase the visibility by increasing the luminance on the entire screen.

### Second Embodiment

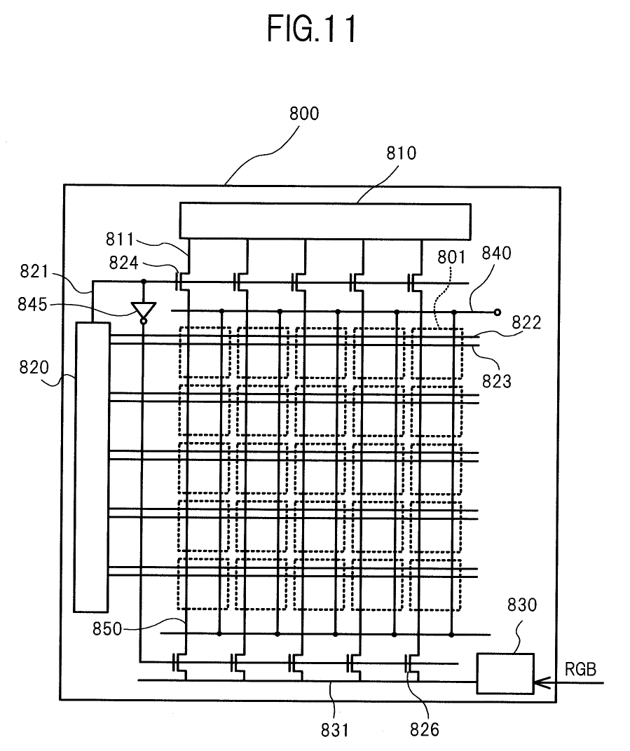

FIG. 11 schematically shows a TFT substrate 800 according to the second embodiment of the invention. In this embodiment, an organic EL display device in which the TFT substrate 800 is installed has the same configuration as the organic EL display device 100 of the first embodiment shown in FIG. 1.

The TFT substrate 800 includes pixels 801 which are minimum display units and are arranged in a matrix form, a data signal driving unit 810 that outputs a data signal 811 corresponding to a grayscale value to be displayed, a gate driving unit 820 that outputs a signal for controlling TFT switches and the like arranged in each pixel 801, a rectangular wave driving unit 830 that outputs a rectangular wave signal 831, which is an emission period signal of a rectangular wave for achieving lighting, to each pixel 801, and a first select switch 824 and a second select switch 826 that are configured to select either one of the rectangular wave signal 831 and the data signal 811 so as to be input to an input signal line 850.

Here, the signal that is output from the gate driving unit 820 to each pixel 801 includes a signal select signal 821, a lighting control signal 822, and a reset signal 823. In the figure, similarly to FIG. 2 of the first embodiment, only a small number of pixels 801 are shown in a simplified configuration so as not to complicate the figure.

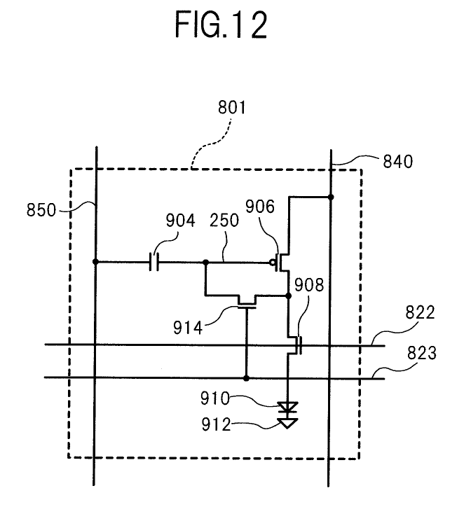

FIG. 12 schematically shows a circuit in the pixel 801. As shown in the figure, the pixel 801 includes an organic EL device 910 which is a self-luminous body, an organic EL driving TFT 906 which functions as a switch that drives the organic EL device 910, and which has a drain connected to the anode side of the organic EL device 910 via a lighting control switch 908 described later, a storage capacitor 904 that is disposed on the gate side of the organic EL driving TFT 906, a reset switch 914 which is connected so as to connect the drain and gate sides of the organic EL driving TFT 906 and which is driven by a reset signal 823, a lighting control switch 908 which is disposed on the source side of the organic EL driving TFT 906 and is driven by the lighting control signal 822, and a common electrode 912 that is connected to the cathode side of the organic EL device 910. In addition, a power supply line 840 is connected to a source side of the organic EL driving TFT 906.

The lighting control switch 908 and the reset switch 914 are formed by NMOS transistors and they will be turned on when the gate signal thereof is High. In this embodiment, the rectangular wave driving unit 830 has the same configuration as the rectangular wave driving unit 230 of the first embodiment shown in FIG. 3 and performs the same operations as shown in FIGS. 4 to 7.

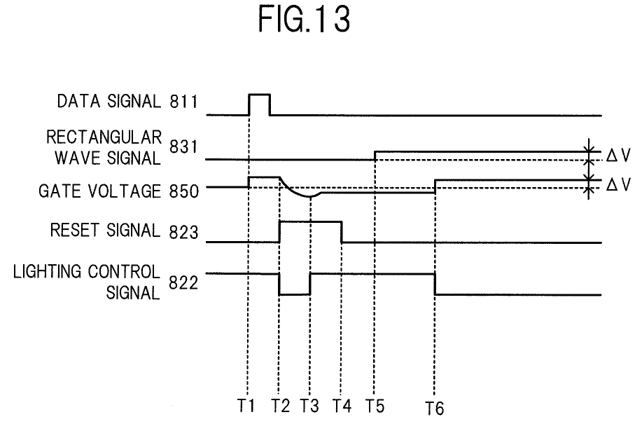

FIG. 13 is a timing chart showing the patterns of changes in signals being controlled when the organic EL device 910 is lighted. In the second embodiment, since the lighting control switch 908 is formed by a NMOS transistor differently from the lighting control switch 308 of the first embodiment, the Low and High states of the lighting control signal 822 are reversed in the timing chart. The other features and operations are the same as those of the timing chart of the first embodiment shown in FIG. 10, and the detail description thereof will be omitted.

Accordingly, in the second embodiment, similarly to the first embodiment, even when an image is bright over the entire screen due to a reason such as the image captured in a bright outdoor place, it is possible to secure sufficient contrast and visibility.

In addition, as described above, with the sufficient contrast, it is possible to suppress power consumption and extend the lifespan of the organic EL device 910.

In addition, since the luminance on the entire screen is changed by changing the reference voltage, it is possible to change the luminance on the entire screen regardless of the data corresponding to the grayscale value stored for each pixel.

In addition, as shown in FIGS. 8 and 9, when the APL value is small, the correction amount ΔV has a negative value. Therefore, when the entire screen is dark, it is possible to increase the visibility by increasing the luminance on the entire screen.

In the first and second embodiments described above, the luminance on the entire screen is increased when the entire screen is dark, whereas the luminance on the entire screen is decreased when the entire screen is bright. However, the same control may be performed with the peak luminance. Specifically, when the entire screen is bright, the correction amount ΔV may be set to a further negative value in order to increase the peak luminance. When the entire screen is dark, the correction amount ΔV may be set to a positive value in order to decrease the peak luminance.

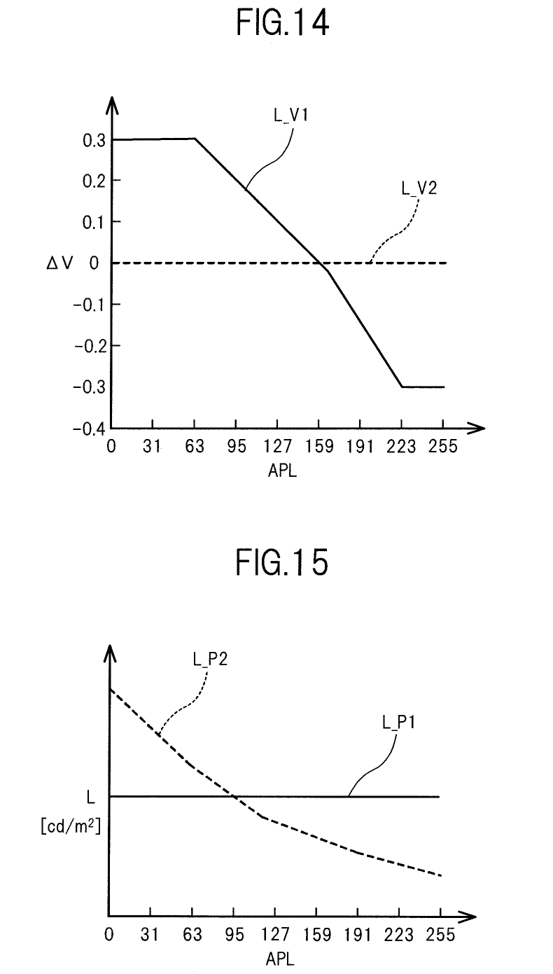

FIG. 14 is a graph showing the relationship between the correction amount ΔV and the APL, and FIG. 15 is a graph showing the relationship between the peak luminance L and the APL. In the graphs, L_V1 in FIG. 14 and L_P1 in FIG. 15 depicted by the solid line are characteristics obtained by the same control, and L-V2 in FIG. 14 and L_P2 in FIG. 15 depicted by the dotted line are characteristics obtained by the same control. For the respective APL values, when the correction amount ΔV is 0 (see the dotted line L_V2 in FIG. 14), as depicted by the dotted line L_P2 in FIG. 15, the peak luminance L decreases naturally as the APL value increases. Therefore, in order to maintain the value of the peak luminance to be constant, the value of the correction amount ΔV is controlled so as to decrease as the APL value increases (see the solid line L_V1 in FIG. 14). By doing so, it is possible to maintain the peak luminance to be constant as depicted by the solid line L_P1 in FIG. 15.

In addition, in the first and second embodiments described above, when the outdoor mode is set, the APL value is calculated and the luminance on the entire screen is controlled. Although such an operation may be performed at all times, the operation may be performed in response to detection of the continuous use time of the organic EL display device or the surrounding brightness. On the other hand, the parameters AP1 to AP3 and ΔV1 to ΔV3 may be calculated and set based on the detection results of the continuous use time of the organic EL display device or the surrounding brightness.

In addition, the invention is not limited to the circuit configuration shown in FIGS. 2 and 3 and FIGS. 11 and 12, used in the first and second embodiments described above, but can be applied to other display devices that use a self-luminous body that is lighted based on a reference voltage.

Although not particularly mentioned in the first and second embodiments described above, a luminous material used in an organic EL layer may be a low-molecular material or a high-molecular material, and a light extracting direction used in the organic EL panel may be a bottom-emission method or a top-emission method.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A display device comprising:
a light emitting device, which is a self-luminous body, emits light when a reference voltage is applied to a plurality of pixels in which voltages based on grayscale values are stored;
an aggregate amount calculation unit that calculates an aggregate amount by summing grayscale values of the plurality of pixels for one screen;
a reference voltage correction unit that calculates a correction amount of the reference voltage based on the aggregate amount to correct the reference voltage; and
a reference voltage output unit that outputs a correction reference voltage corrected by the reference voltage correction unit.

2. The display device according to claim 1, wherein the light emitting device is an organic electro-luminescent device.

3. The display device according to claim 1, wherein the aggregate amount is an average picture level that is expressed by the sum of the grayscale values.

4. The display device according to claim 1, wherein the aggregate amount is a weighted sum with a different weight for each color.

5. The display device according to claim 1, wherein the reference voltage correction unit corrects the reference voltage so that lighting intensity of the light emitting device is decreased when the aggregate amount has a value indicating a high degree of brightness and, the reference voltage correction unit corrects the reference voltage so that lighting intensity of the light emitting device is increased when the aggregate amount has a value indicating a low degree of brightness.

6. The display device according to claim 1, wherein the reference voltage correction unit corrects the reference voltage so that a peak luminance of the light emitting device is increased when the aggregate amount has a value indicating a high degree of brightness and, the reference voltage correction unit corrects the reference voltage so that a peak luminance of the light emitting device is decreased when the aggregate amount has a value indicating a low degree of brightness.

7. The display device according to claim 1, wherein the reference voltage correction unit includes parameters for calculating the correction amount and determines the correction amount by substituting the aggregate amount into a calculation equation using the parameters.

8. The display device according to claim 7, wherein the parameters are determined based on settings input by a user.

9. The display device according to claim 7, wherein the parameters are determined based on ambient light intensity.

10. The display device according to claim 7, wherein the parameters are determined based on a continuous use time.

11. The display device according to claim 1, wherein the aggregate amount calculation unit, the reference voltage correction unit, and the reference voltage output unit are configured by a circuit on a TFT substrate having the pixels.

12. A display method of a display device comprising:
an aggregate amount calculation step of calculating an aggregate amount by summing grayscale values of a plurality of pixels for one screen;
a reference voltage correction step of calculating a correction amount of the reference voltage based on the aggregate amount calculated in the aggregate amount calculation step to correct the reference voltage; and
a reference voltage output step of outputting the reference voltage based on the reference voltage corrected in the reference voltage correction step so as to emit light by a light emitting device, which is a self-luminous body, at the plurality of pixels in which voltages based on the grayscale values are stored.
